(19) United States
(12) Patent Application Publication
(10) Pub. No.: US 2009/0019919 A1
(43) Pub. Date: Jan. 22, 2009

(54) Apparatus for taking odor samples

(76) Inventor: Geert Philip Derumez, Oostkamp (BE)

Correspondence Address: JAMES C. WRAY, 1493 CHAIN BRIDGE ROAD, SUITE 300, MCLEAN, VA, 22101, US

(21) Appl. No.: 11/904,221

(22) Filed: Sep. 26, 2007

(30) Foreign Application Priority Data
Jul. 20, 2007 (GB) 07 14 172.4

(51) Int. Cl. G01N 27/00

(52) U.S. Cl. 73/23.34

(57) ABSTRACT

The present invention relates to an apparatus for taking odor samples that comprises a closed circuit, provided with a heating element and a cooling element for initiating and/or maintaining a circulation of gas in said closed circuit, which circulated gas takes along the odor from an odor source to absorbing material which absorbs the odor. This apparatus allows e.g. odor analysis where the odor source cannot be taken to the odor detector, or the odor detector cannot be taken to the odor source. It also allows to collect particles from human tissue samples, which resemble particles that normally come along with human sweat.

The present invention relates to an apparatus for taking odor samples. This apparatus is intended for taking odor samples, but its use is not limited to taking odor samples.

For analysis of odors, the odor source itself is mostly used as a sample.

These odor samples are commonly diluted for testing the presence of odors and for identifying and recognizing odors, as is described in U.S. Pat. No. 6,018,984, U.S. Pat. No. 6,411,905, U.S. Pat. No. 5,627,307 and U.S. Pat. No. 3,902,851. Sometimes these samples are humidified to assure a better detection, as described in US 2001/0027678. The as such derived odor sample is then presented to the odor detector (a human panel, an animal like a dog or an artificial olfactory system).

In EP 1 099 949, a sample gas containing the odor component is passed through a collector tube containing an absorbent which absorbs this odor component at normal and subnormal temperatures and desorbs it when heated. After a specified amount of odor component is thus absorbed to the absorbent in the collection tube, the tube is heated and an inert gas is passed through as a carrier gas such that the desorbed odor component is carried to the detectors. The concentration of the odor component in the odor sample can in this way be controlled by the manner of flow of the inert carrier gas.

Analysis of odors can be executed as well by humans, by animals like dogs, or by means of artificial olfactory systems, such as electronic noses.

A disadvantage of the known apparatus for taking odor samples is that either the odor source has to be taken to the odor detector or the odor detector has to be taken to the odor source. In cases where the odor of fixed elements has to be analyzed, the odor detector (a human panel, an animal like a dog or an artificial olfactory system) has to be taken in situ. This is not always easily organized.

Several applications of analysis of odors are well known, such as e.g. detection of gas leaks, food testing, drug detection with dogs, searching for truffles with pigs, etc. Sharks smell blood many kilometers away.

Research shows that analysis of odors can also be applied for diagnosis of human or animal medical conditions or diseases.

For example is in patent publication WO 9,965,386 described how the presence of a pathologic process in a lung of a mammal is detected by applying exhaled gas of a mammal to an electronic nose. Data derived from the electronic nose is used to determine whether a pathologic process is present in the lung of a mammal. The pathologic process may also be a lung infection such as pneumonia. Also, a mammalian fluid sample obtained from the sinus or nose is applied to an electronic nose to determine if the fluid sample contains significant amounts of cerebrospinal fluid.

Similarly is in US 2003008407 described how a set of volatile markers could be determined which are characteristic of a particular condition or disease, and which will be found in the exhaled breath of a person or odor from other parts of a body or from an entity. These markers are detected in the breath odor or gaseous emanations from the body or entity non-invasively using a volatile substance detector of sufficient sensitivity, such as an artificial olfactory system.

Exploratory work has shown that patterns of biochemical markers have been found in the exhaled breath of patients with lung and breast cancers that are distinguishable from those of healthy patients. However chemical analysis of exhaled breath has not shown suitability for individual diagnosis. Too complex and too expensive artificial olfactory systems should be build to assure good detection. Therefore, research is conducted to use dogs as odor detectors for diagnosis of human or animal medical conditions or diseases. Dogs show detection thresholds as low as parts per trillion and have a capability of discriminating between complex chemical mixtures. They have a great variety of smelling receptors in their nose and have a great convergence of neurons from the nose to the brain.

In a recently published article (Integrative Cancer Therapies 5(1); 2006), it is described how dogs can detect lung cancer by sniffing breath samples with 99% sensitivity and specificity and breast cancer with 88% sensitivity and 98% specificity. A study at the Florida State University Sensory Research Institute also showed that dogs could sniff out melanoma 99% of the time.

Existing diagnostic methods for many cancers often have limited capabilities, a destructive nature to the human body, often are rather expensive and are therefore used for preventive diagnoses at large intervals, etc. It is therefore a very promising idea that dogs could be used in the near future for diagnosis of human or animal medical conditions or diseases. With dogs, early detection of cancer could be reached, which allows treatment with lower toxicity and predicts longer survival. However, when considering other types of cancer, which are not related to the respiratory tract or to the urinary tract, it is not evident to train dogs to recognize the typical odor of these other types of cancer. Samples of these cancers could be used to take diluted odor samples. However, these samples are collected in hospitals or laboratories under strict conditions, which do not allow entering of dogs. These samples cannot leave these building either.

It is therefore an object of the present invention to provide an apparatus for taking odor samples, which allows that the odor source and the odor detector do not have to be present at the same place to perform odor analysis.

This object of the invention is achieved with an apparatus for taking odor samples, wherein the apparatus comprises a closed circuit, provided with a heating element and a cooling element for initiating and/or maintaining a circulation of gas in said closed circuit, which circulated gas takes along the odor from an odor source to absorbing material which absorbs the odor.

With such an apparatus, this apparatus can in abovementioned example be taken to the hospital or laboratory where cancer samples are collected. Odor samples can be taken of these cancer samples, without interfering the strict preservation of the cancer samples, and can be taken along.

This apparatus could also be used for other applications.

The closed circuit assures that only the gas in this circuit comes into contact with the odor source. In this way, the odor samples are not disturbed by outside air and odors.

As absorbing material filter paper can advantageously be applied.

Preferably, the parts out of which the apparatus is built, are according to this invention substantially odorless. Materials as rubber or oil have a typical odor and should be avoided as this odor can interfere with the odor source. For training, odor samples preferably only contain the odor from the odor source. When using materials which are substantially odorless, odor samples can be taken, which substantially contain the odor of the odor source, without being disturbed by other odors.

Moreover is the closed circuit preferably air-tight. This also reduces the risk that other odors could interfere with the odor from the odor source.

In a particular embodiment of an apparatus according to this invention, the closed circuit contains a first column, provided with the heating element and provided for containing the odor source and a second column, provided with the cooling element and provided for containing the absorbing material.

Preferably, an apparatus according to this invention is further provided with a funnel to guide the odor and particles towards the absorbing material. As such particles causing the odor in which one is interested is concentrated in one spot of the absorbing material. This spot can then closely be monitored. When one searches e.g. for a reagent which reacts with the particles causing the odor in which one is interested, one can apply a possible reagent to the absorbing material and observe if it reacts with the particles. A possible application is developing a cream, containing found reagents which might be used to diagnose cancer.

To monitor the spot in which the particles are concentrated, an apparatus according to this invention is preferably provided with an image taking system to take images of at least part of the absorbing material. This image taking system can contain fiber optics to take images of the spot in which the particles are concentrated and can contain an LCD screen to picture the taken images. Images taken with such an image taking system could also be loaded into a computer, with e.g. a USB connection, as such allowing to compare the images taken during the process with a suitable software program, or to compare these images with images from a database.

According to this invention, a water damp containing gas can advantageously be used as gas for circulation. Normally, for odor analysis with human panel or with dogs, preferably humidified odor samples are used, while for odor analysis with an artificial olfactory system, preferably dry odor samples are used. When collecting odor samples using water damp containing gas similarly to human sweat, an odor sample will be contained which resembles the odor a dog would sniff situated near the human. Analogously, a cream, one develops to diagnose cancer, will be tested on a sample, which resembles human sweat.

Preferably, an apparatus according to this invention, in which a water damp containing gas is used as gas for circulation, is provided with at least one slope in the closed circuit, to conduct water damp form the water damp containing gas. This slope is advantageously provided in the second column of a closed circuit, where water damp is condensed and otherwise would not be redirected towards the first column.

Furthermore, at least part of the closed circuit is preferably insulated. As such, one can provide that condensation of water damp from the water damp containing gas takes place too early in the closed circuit.

In a further particular embodiment of an apparatus according to this invention, a control circuit for controlling the circulation is provided with parameters measured in the closed circuit with at least one sensor as input and with control parameters for controlling the heating element and/or the cooling element as output.

Under controlled conditions, as such, it becomes possible to take reproducible odor samples.

In a specific embodiment according to this invention, temperature probes are provided to measure the temperature of the gas at several places in the closed circuit. With such an embodiment, preferably, the temperature measured at several places in the closed circuit with the temperature probes is used as input to the control circuit.

In a further embodiment according to this invention, a manometer is provided for measuring the gas pressure in the closed circuit. With such an embodiment, preferably, the gas pressure measured in the closed circuit with the manometer is used as input to the control circuit.

In a further more specific embodiment according to this invention, a moisture sensor is provided for measuring the moisture level in the control circuit. With such an embodiment, preferably, the moisture level measured in the closed circuit is used as input to the control circuit.

An apparatus according to this invention further preferably contains a pressure relief valve which is provided for controlling the gas pressure in the closed circuit.

Further distinctive features and characteristics will be clarified in the following description of two specific embodiments of the invention as represented in the attached drawings. It should be noted that this embodiment is only given by way of example and implies no restriction in the general scope of the invention as that appears from the above description and from the claims at the end of this text.

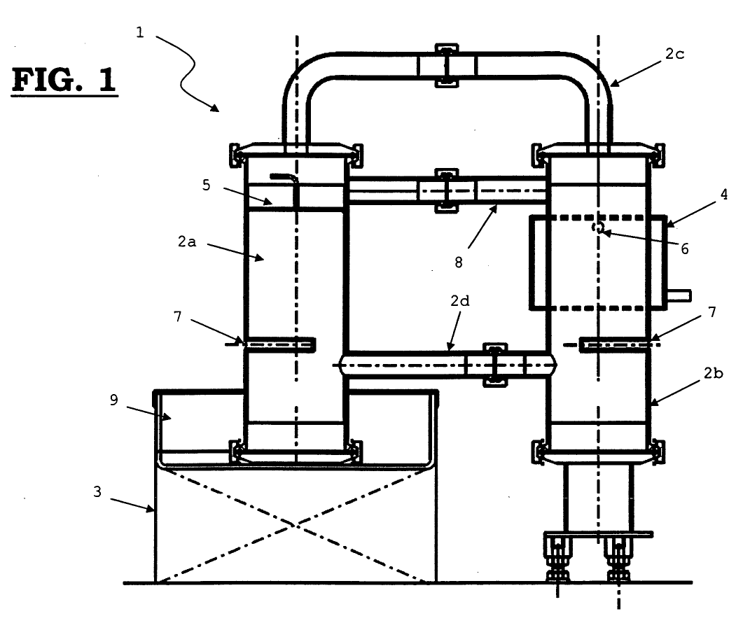

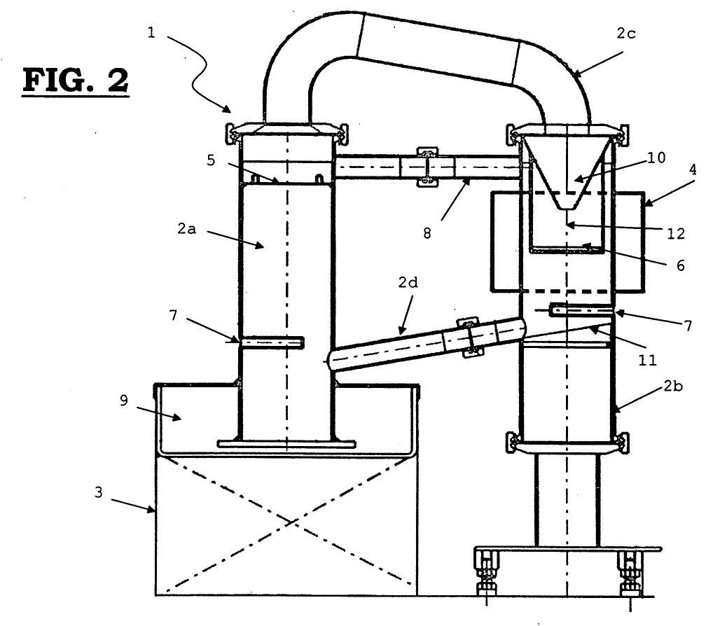

In this description, by means of reference numbers, reference will be made to the attached FIGS. 1 and 2, wherein:

FIG. 1 shows a sectional view of a first preferred embodiment of an apparatus for taking odor samples according to the invention;

FIG. 2 shows a sectional view of a second preferred embodiment of an apparatus for taking odor samples according to the invention.

Reference numerals in FIGS. 1 and 2, refer to the following parts of the preferred embodiments of an apparatus for taking odor samples according to this invention:
1 apparatus
2a first column
2b second column
2c connection tube
2d connection tube
3 heating element
4 cooling element
5 odor source holder
6 absorbing material holder
7 temperature probe
8 support beam
9 water reservoir
10 funnel
11 slope
12 image taking spot

The preferred embodiments of an apparatus (1) for taking odor samples according to this invention as pictured in FIGS. 1 and 2, comprise a closed circuit, containing a first column (2a), a second column (2b) and two connection tubes (2c, 2d). A support beam (8) supports the two columns.

The first column (2a) of the closed circuit is provided with a heating element (3) and the second column (2b) is provided with a cooling element (4). The closed circuit comprises a gas. By heating this gas with the heating element (3), the gas will mount and flow through the upper connection tube (2c) to the second column (2b) by convection. Similarly, by cooling the gas with the cooling element (4), the gas will descend and flow to the first column (2a) by subsidence. In this way, a circulation of the gas in said closed circuit (2a, 2b, 2c, 2d) is initiated. To maintain a circulation of the gas in said closed circuit (2a, 2b, 2c, 2d), both the heating element (3) as the cooling element (4) should be turned on. Otherwise, in case only the heating element (3), or only the cooling element (4) is turned on, after a certain period the gas in the whole closed circuit (2a, 2b, 2c, 2d) would obtain the same temperature and the gas would no longer circulate under convection.

For taking odor samples, the first column (2a) of this embodiment of an apparatus for taking odor samples (1) according to this invention, is provided for containing the odor source with an odor source holder (5). This odor source holder (5) can for example be in the form of a perforated platform, which does not prevent the circulation of the gas. This platform is preferably detachably provided in the first column (2a).

The second column (2b) of this apparatus (1) is provided for containing the absorbing material (8). While the gas circulates in the closed circuit (2a, 2b, 2c, 2d), the circulated gas will take along the odor from the odor source (5) provided in the first column (2a) to the absorbing material (6) in the second column (2b), which absorbs the odor. This absorbing material (6) is advantageously filter paper, as this will not prevent the circulation of the gas, while absorbing the odor. This absorbing material (6), containing the odor can then be presented to the odor detector as diluted odor sample.

The intention of this preferred embodiment of an apparatus (1) for taking odor samples, is to be used to take odor samples from human tissue, in order to detect markers which are characteristic of a particular condition or disease. To obtain these odor samples, one can copy the conditions of the human body as good as possible to derive an odor sample from human tissue. In this view, the first column (2a) represents the interior of a human, as it contains a tissue sample. The second column (2b) represents then the surface of the human body. The odor sample taken in the second column (2b) can with this apparatus (1) be derived in such a way as to represent either a sample which would be derived from breath, either from sweat, or from urine.

In the pictured embodiment of an apparatus (1) for taking odor samples, water in a water reservoir (9) is heated with the heating element (3). The first column (2a) is indirectly heated with the heated water. To copy the process in a human body which takes the odor from for example a disease spot (the human tissue in the odor source holder (5)) to the surface (absorbing material holder (6)), samples can be taken at the body temperature of a human, which is about 37° C. A water damp containing gas can be used to copy the condition of the human body, for which water is a main element. The indirect heating will cause a breeze, which does not destruct the tissue sample and which will smoothly take the odor to the absorbing material holder (6). The second column (2b) is cooled with water circulation as cooling element (4), in order to maintain the smooth circulation.

The specific embodiment of an apparatus (1) according to this invention of FIG. 2 is adapted to use water damp containing gas. Therefore, the connection tubes (2c, 2d) are mounted in a slope and an additional slope (11) is provided in the second column (2b). The slopes descend in such a way, that when the water damp from the water damp containing gas condenses, it will further be directed in the closed circuit (2a, 2b, 2c, 2d) in the direction of the circulation of the gas. Arrived at the heating element (3), the condense can evaporate again. The part of the connection tube (2c), situated above the first column (2a), can preferably be insulated, in order to prevent the water damp to condense before it can reach the slope of the connection tube (2c). As such, one can assure that the water damp will reach the absorbing material (6) and provide a usable odor sample.

The embodiment of an apparatus (1) according to this invention of FIG. 2 is further provided with a funnel (10) to guide the odor and particles towards the absorbing material (6). As such, particles causing the odor in which one is interested is concentrated in one spot (12) of the absorbing material (6). This spot (12) can then closely be monitored with e.g. an image taking system to take images of at least part of the absorbing material. Such an image taking system is not pictured in FIG. 2. This image taking system could contain fiber optics to take images of the spot in which the particles are concentrated and could contain an LCD screen to picture the taken images. Images taken with such an image taking system could also be loaded into a computer, with e.g. a USB connection, as such allowing to compare the images taken during the process with a suitable software program, or to compare these images with images from a database.

Preferably all parts of the apparatus (1) as illustrated in both embodiments of FIGS. 1 and 2 are detachably mounted. This allows insertion and extraction of the odor source (5) and the absorbing material (6) in the apparatus (1). With detachably mounted parts, the different parts can also be cleaned separately after use of the apparatus (1), for example using steam.

In these preferred embodiments of an apparatus (1) for taking odor samples according to this invention, temperature probes (7) can be inserted in the recesses which are provided in both columns. The temperatures measured with these temperature probes (7) can be used as input to a control circuit for controlling the circulation of the gas in the closed circuit. The output of this control circuit are then preferably control parameters for controlling the heating element (3) and/or the cooling element (4).

With an apparatus (1) according to this invention, odor samples can as well be taken at positive temperatures as at negative temperatures. For taking odor samples from human tissue as described above, samples are preferably taken at about 37° C. However, samples could also be taken from frozen odor sources, which may not be thawed. In this case, odor samples will be taken at negative temperatures.

This apparatus (1) could further be provided with a manometer for measuring the gas pressure in the closed circuit (2a, 2b, 2c, 2d) and/or with a moisture sensor for measuring the moisture level in the closed circuit (2a, 2b, 2c, 2d). For taking odor samples from human tissue as described above, this is however not necessary, considering the smooth process with which the odor samples are derived. The gas pressure measured in the closed circuit (2a, 2b, 2c, 2d) with a manometer and/or the moisture level measured in the closed circuit (2a, 2b, 2c, 2d) with a moisture sensor could then also be used as input to the control circuit. Both manometer and moisture sensor are not pictured in FIG. 1 or 2, as these embodiments are intended for taking odor samples from human tissue, copying the conditions of a human body, and a manometer is not necessary in this case.

Furthermore the apparatus (1) can be provided with a pressure relief valve for controlling the gas in the closed circuit (2a, 2b, 2c, 2d).

This pressure relief valve is as well not pictured in FIG. 1 or 2, as this is not necessary for taking odor samples from human tissue, copying the conditions of a human body.

1. Apparatus (1) for taking odor samples, wherein the apparatus (1) comprises a closed circuit (2a, 2b, 2c, 2d), provided with a heating element (3) and a cooling element (4) for initiating and/or maintaining a circulation of gas in said closed circuit (2a, 2b, 2c, 2d), which circulated gas takes along the odor from an odor source (5) to absorbing material (6) which absorbs the odor.

2. Apparatus (1) according to claim 1, wherein the parts out of which the apparatus is built, are substantially odorless.

3. Apparatus (1) according to claim 1, wherein the closed circuit (2a, 2b, 2c, 2d) is air-tight.

4. Apparatus (1) according to claim 1, wherein the closed circuit (2a, 2b, 2c, 2d) contains a first column (2a), provided with the heating element (3) and provided for containing the odor source (5) and a second column (2b), provided with the cooling element (4) and provided for containing the absorbing material (6).

5. Apparatus (1) according to claim 1, wherein the closed circuit (2a, 2b, 2c, 2d) is provided with a funnel (4) to guide the odor and particles towards the absorbing material (6).

6. Apparatus (1) according to claim 1, wherein an image taking system is provided to take images of at least part of the absorbing material (6).

7. Apparatus (1) according to claim 1, wherein a water damp containing gas is used.

8. Apparatus (1) according to claim 7, wherein at least one slope (11) is provided in the closed circuit (2a, 2b, 2c, 2d) to conduct water damp from the water damp containing gas.

9. Apparatus (1) according to claim 1, wherein at least part of the closed circuit (2a, 2b, 2c, 2d) is insulated.

10. Apparatus (1) according to claim 1, wherein a control circuit for controlling the circulation is provided with parameters measured in the closed circuit (2a, 2b, 2c, 2d) with at least one sensor (7) as input and with control parameters for controlling the heating element (3) and/or the cooling element (4) as output.

11. Apparatus (1) according to claim 1, wherein temperature probes (7) are provided to measure the temperature of the gas at several places in the closed circuit (2a, 2b, 2c, 2d).

12. Apparatus (1) according to claim 10, wherein the temperature measured at several places in the closed circuit (2a, 2b, 2c, 2d) with the temperature probes (7) is used as input to the control circuit.

13. Apparatus (1) according to claim 1, wherein a manometer is provided for measuring the gas pressure in the closed circuit (2a, 2b, 2c, 2d).

14. Apparatus (1) according to claim 13, wherein the gas pressure measured in the closed circuit (2a, 2b, 2c, 2d) with the manometer is used as input to the control circuit.

15. Apparatus (1) according to claim 1, wherein a moisture sensor is provided for measuring the moisture level in the control circuit.

16. Apparatus (1) according to claim 15, wherein the moisture level measured in the closed circuit is used as input to the control circuit.

17. Apparatus (1) according to claim 1, wherein a pressure relief valve is provided for controlling the gas pressure in the closed circuit.
